(19) United States
(12) Patent Application Publication
(10) Pub. No.: US 2008/0082668 A1
(43) Pub. Date: Apr. 3, 2008

(54) PRESENCE INFORMATION DELIVERY BASED ON SESSION PARTICIPATION

(75) Inventors: Ryan N. Yoakum, Cary, NC (US); John H. Yoakum, Cary, NC (US); Steve J. McKinnon, Cary, NC (US)

Correspondence Address: WITHROW & TERRANOVA, P.L.L.C., 100 REGENCY FOREST DRIVE, SUITE 160, CARY, NC, 27518, US

(73) Assignee: NORTEL NETWORKS LIMITED, St. Laurent (CA)

(21) Appl. No.: 11/536,414

(22) Filed: Sep. 28, 2006

(51) Int. Cl. G06F 15/16; G08B 19/00

(52) U.S. Cl. 709/227; 340/521

(57) ABSTRACT

The present invention addresses the shortcomings of existing presence systems by taking into consideration whether a subscriber to presence information of a monitored person is engaged in a communication session with the monitored person. Basic presence information for the monitored person is provided to subscribers who are not engaged in a communication session with the monitored person. More detailed presence information for the monitored person, referred to as session related presence information, is provided to subscribers who are engaged in a communication session with the monitored person. The session related presence information is generally information about the monitored person or her environment and communication equipment that is particularly beneficial to those subscribers who are actively engaged in a communication session with the monitored person.

### FIELD OF THE INVENTION

The present invention relates to providing presence information, and in particular to controlling the delivery of presence information based on session participation.

### BACKGROUND OF THE INVENTION

Given the rapid expansion of mobile communications along with the pervasiveness of email and instant messaging, determining the right method or location to contact someone often proves difficult. Many people are associated with numerous telephone numbers, email addresses, instant messaging identifiers, and the like. Trying to contact such people often leads to leaving one or more voicemails and perhaps sending email or instant messaging messages prior to making contact. Further, trading numerous voicemails prior to finally connecting with one another is commonplace.

Presence systems have been developed to address the difficulty in determining if someone is available to communicate, and perhaps how best to communicate with that person when she is available. In general, presence systems monitor state information from one or more devices or networks associated with a particular person, and process the state information to create presence information bearing on the relative availability of that particular person. The presence information is then sent to those subscribers interested in knowing the relative availability of the particular person. The state information generally bears on a person's physical presence or activity with respect to a certain device.

An exemplary presence system is illustrated in FIG. 1. A communication network 10 is configured to support communications with any number of monitored entities 14, directly or indirectly through another communication network 16, as well as supporting communications with various subscriber entities 18 to which presence information is delivered. A presence server 20 is provided and includes a presence function 22, which processes the state information to create presence information to provide to the subscriber entities 18. The subscriber entities 18 may include presence applications 24, which process the presence information and operate to control the subscriber entity 18 as necessary to provide presence alerts to the subscriber based on the presence information.

With reference to FIG. 2, the basic flow for presence processing is illustrated. In operation, the monitored entities 14 will recognize certain states or state changes in light of a monitored person's interaction, use, or physical presence. The monitored entity 14 will provide state information to the presence function 22 as states change, on a periodic basis, or upon request from the presence function 22. Notably, the communication network 16 may actually generate the state information in light of certain interactions with the monitored entity 14, or may simply pass state information from the monitored entity 14 to the presence function 22. Regardless of how the state information is received, the state information for a monitored person is processed in light of defined presence rules and the state information to create presence information for the monitored person. Presence information is then sent to subscribing presence applications 24. The presence information may be provided to the presence applications 24 when the presence information changes, on a periodic basis, or upon request from the presence application 24.

Unfortunately, the same presence information for a monitored person is generally provided to all subscribers. Although more detailed presence information may be available to share with subscribers, privacy concerns have limited the amount of information that is deemed appropriate to share with all subscribers. As such, there is a constant trade-off between providing detailed presence information to subscribers and addressing prevailing privacy concerns.

In many instances, parties engaged in a communication session could benefit from more detailed presence information. For example, one party to a communication session may find that it is useful to know what communication or application tools are available to the other party or if the other party to the communication session is using a speaker phone or wireless phone. For a conference session, participants may find it beneficial to know what parties are engaged in the session or whether another participant is on mute or engaged in another communication session. Although more detailed presence information is potentially available, the monitored person may not feel comfortable sharing such information with all subscribers. However, the monitored person participating in a communication session may feel more comfortable providing more detailed presence information to those subscribers who are also participating in the session.

Accordingly, there is a need to provide a reliable presence system that is able to provide more detailed presence information for a monitored person to subscribers who are engaged in a communication session with the monitored person. There is a further need to provide basic information to subscribers who are not engaged in a communication session with the monitored person and provide more detailed presence information to subscribers who are engaged in a communication session with the monitored person.

### SUMMARY OF THE INVENTION

The present invention addresses the shortcomings of existing presence systems by taking into consideration whether a subscriber to presence information of a monitored person is engaged in a communication session with the monitored person. Basic presence information for the monitored person is provided to subscribers who are not engaged in a communication session with the monitored person. More detailed presence information for the monitored person, referred to as session related presence information, is provided to subscribers who are engaged in a communication session with the monitored person. The session related presence information is generally information about the monitored person or her environment and communication equipment that is particularly beneficial to those subscribers who are actively engaged in a communication session with the monitored person. As such, subscribers will receive different presence information depending on whether or not they are engaged in a communication session with the monitored entity associated with the presence information.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block diagram of a communication network incorporating a presence system.

FIG. 2 illustrates a basic process flow in a presence system.

FIG. 3 is a block representation of a communication environment according to one embodiment of the present invention.

FIG. 4 is a flow diagram for delivering presence information according to one embodiment of the present invention.

FIG. 5 is a flow diagram for controlling session initiation based on user defined conditions according to one embodiment of the present invention.

FIG. 6 is a block representation of a presence server according to one embodiment of the present invention.

FIG. 7 is a block representation of a service node according to one embodiment of the present invention.

FIG. 8 is a block representation of a user terminal according to one embodiment of the present invention.

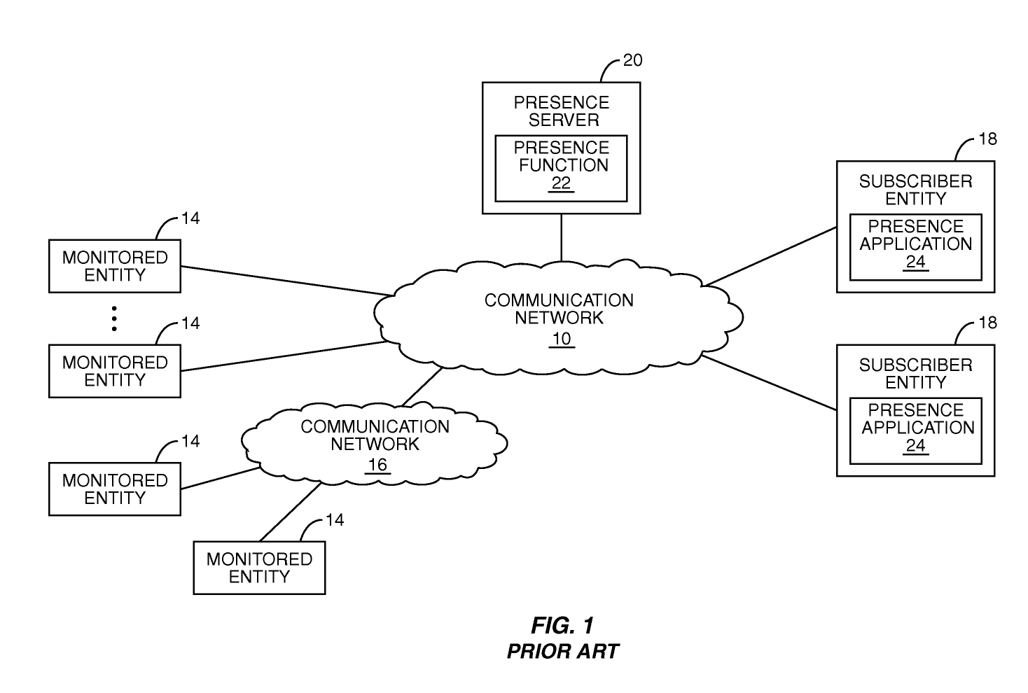

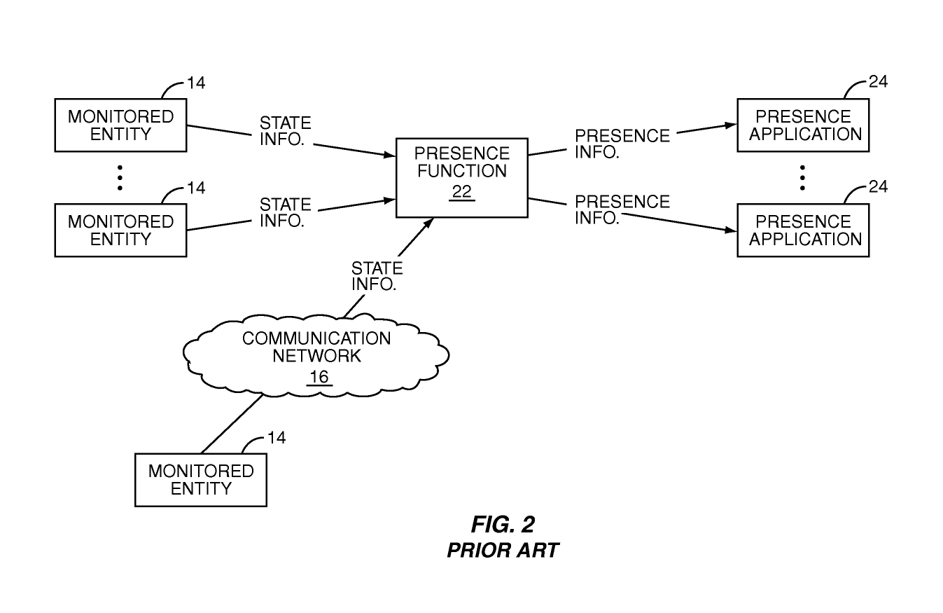

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention addresses the shortcomings of existing presence systems by taking into consideration whether a subscriber to presence information of a monitored person is engaged in a communication session with the monitored person. Basic presence information for the monitored person is provided to subscribers who are not engaged in a communication session with the monitored person. More detailed presence information for the monitored person is provided to subscribers who are engaged in a communication session with the monitored person. The more detailed presence information is referred to as session related presence information and is generally information about the monitored person or her environment and communication equipment that would be particularly beneficial to those subscribers who are actively engaged in a communication session with the monitored person.

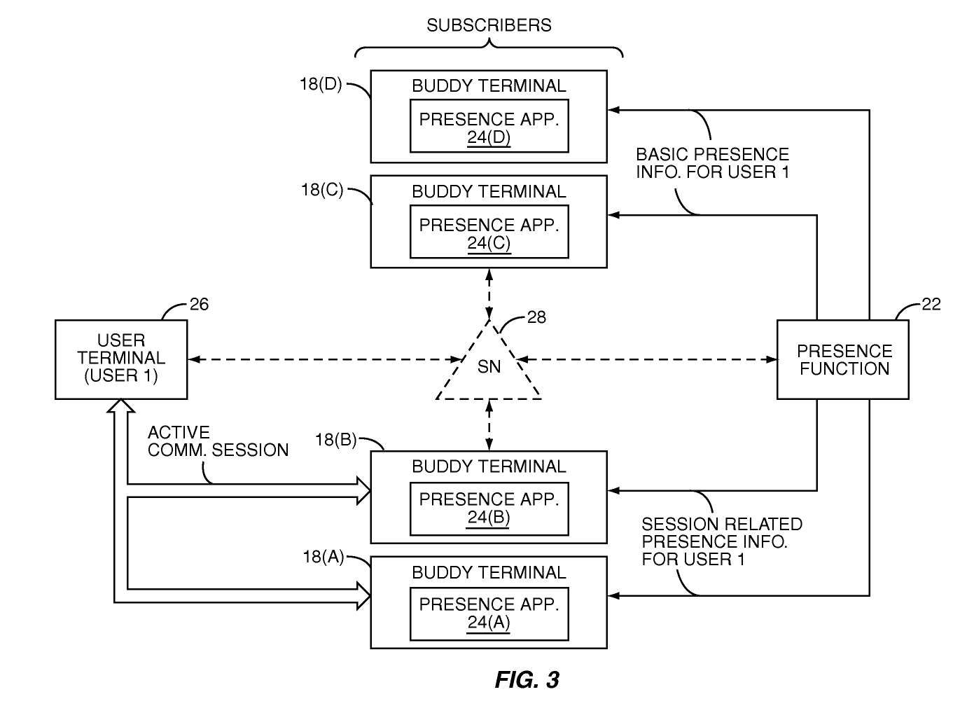

With reference to FIG. 3, a process is illustrated for delivering basic presence information to subscribers who are not engaged in the communication session, and session related presence information to subscribers who are engaged in the communication session. As depicted, the presence function 22 is configured to receive state information for user 1, who is a monitored entity associated with user terminal 26. The presence function 22 processes the state information received from various sources associated with user 1 and is able to generate presence information to subscribers via presence information generated by user 1. The presence information is provided to presence applications 24(A-D), which reside in buddy terminals 18(A-D), which are essentially subscriber entities 18 that are capable of engaging in a communication session with user terminal 26. In this example, buddy terminals 18(C) and 18(D) are not engaged in an active communication session with user terminal 26. Buddy terminals 18(A) and 18(B) are engaged in an active communication session with user terminal 26.

Assume the presence function 22 is capable of deriving state information from user terminal 26 directly, or indirectly through a service node 28 (as illustrated) or other entity to detect that user terminal 26 is engaged in an active communication session with the buddy terminals 18(A) and 18(B). The presence function 22 may have various additional state information from which presence information may be derived. For the present invention, the presence information provided to the buddy terminals 18(A-D) will vary depending on whether or not the buddy terminals 18(A-D) are engaged in an active communication session with the user terminal 26. As depicted, the presence function 22 creates basic presence information for user 1 and delivers the basic presence information to buddy terminals 18(C) and 18(D), which are subscriber entities 18 that are not engaged in an active communication session with the user terminal 26. In contrast, the presence function 22 will use the same state information associated with user 1 to create session related presence information for user 1 and deliver the session related presence information to buddy terminals 18(A) and 18(B), which are actively engaged in a communication session with the user terminal 26.

The service node 28 may provide different functions in different embodiments. For example, the service node 28 may be a proxy for the user terminal 26, provide call or session control for communication sessions between the user terminal 26 and the buddy terminals 18(A-D), or relay state information from the user terminal 26 as well as from the buddy terminals 18(A-D) to the presence function 22. Those skilled in the art will recognize that there are numerous techniques for allowing the presence function 22 to determine that the user terminal 26 is engaged in an active communication session with one or more buddy terminals 18(A-D). Such information may be provided from the user terminal 26 and buddy terminals 18(A) and 18(B) that are engaged in an active communication session. Alternatively, the service node 28 may be able to keep track of this information upon establishing and controlling the active communication session and provide such information to the presence function 22. In yet another embodiment, the user terminal 26 is able to forward state information toward the presence function 22, wherein the state information identifies the user terminal 26 as being engaged in an active communication session with the buddy terminals 18(A) and 18(B).

Although the concepts of the present invention are readily employed in a presence system where the presence function 22 is provided in a separate entity, such as the presence server 20, the concept of selectively delivering basic presence information to buddy terminals 18(C) and 18(D) that are not engaged in an active communication session with the user terminal 26 and providing session related presence information to buddy terminals 18(A) and 18(B) that are engaged in an active communication session may be employed in various entities, including the user terminal 26. As such, the user terminal 26 may monitor various inputs or surrounding conditions, which representing state information, and generate the appropriate presence information for various buddy terminals 18(A-D) depending on their participation in an active communication session with the user terminal 26.

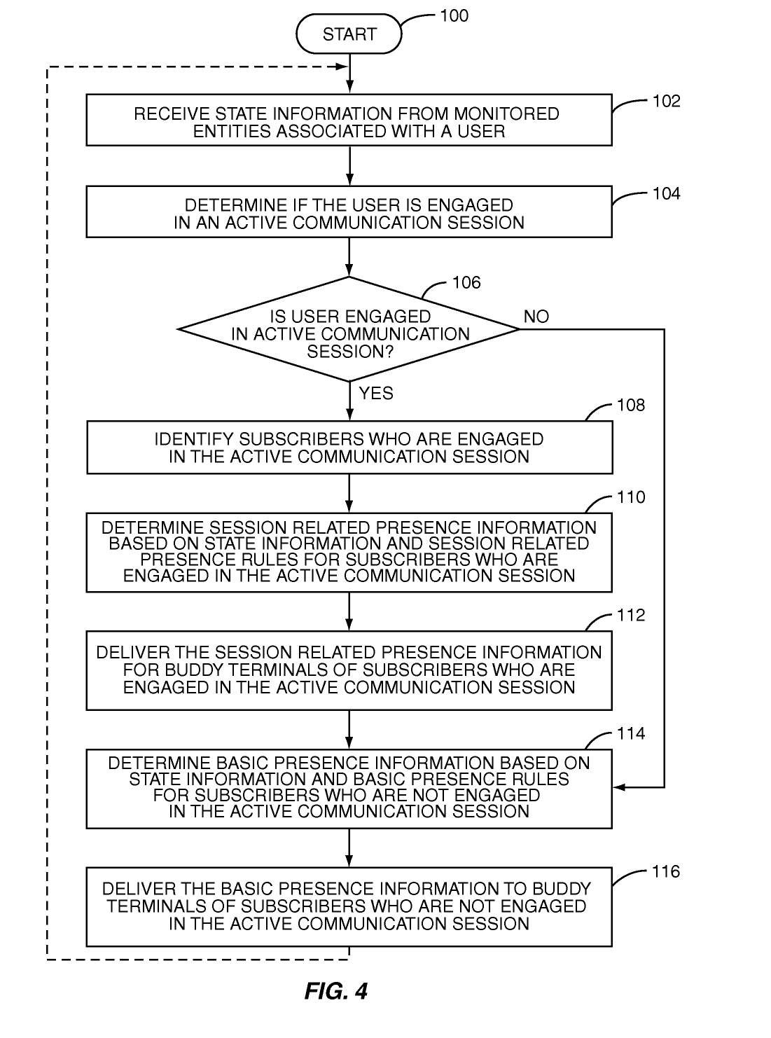

Turning now to FIG. 4, a flow diagram illustrates basic operation of a presence function 22 according to one embodiment of the present invention. The process starts (step 100) when the presence function 22 receives state information from various monitored entities 14, such as the user terminal 26, which are associated with a particular user (step 102). The presence function 22 will also determine if the user is engaged in an active communication session (step 104). If the user is engaged in an active communication session (step 106), the presence function 22 will identify any subscribers who are engaged in the active communication session with the user (step 108). For the subscribers who are engaged in the active communication session with the user, the presence function 22 will determine session related presence information based on available state information and session related presence rules (step 110). The presence function 22 will then deliver the session related presence information to the buddy terminals 18(A) and 18(B) of the subscribers who are engaged in the active communication session (step 112).

The presence function 22 may also determine basic presence information based on state information and basic presence rules for subscribers who are not engaged in the active communication session (step 114). The basic presence information may then be delivered to the buddy terminals 18(C) and 18(D) of the subscribers who are not engaged in the active communication session (step 116).

If the user is not engaged in an active communication session (step 106), a presence function 22 will determine basic presence information based on the state information and basic presence rules for all subscribers who are not engaged in the active communication session with the user. As such, if none of the buddy terminals 18(A-D) were engaged in an active communication session with the user, the basic presence information would be sent to each of the buddy terminals 18(A-D) (steps 114 and 116). Again, the presence function 22 may be provided in a separate entity or in one of the monitored entities 14, such as the user terminal 26, or in any network entity providing other services to subscribers, such as the service node 28.

The difference between the basic presence information and the session related presence information may vary from application to application as well as on the monitored person's and subscribers' desires and needs. For subscribers who have privacy concerns, the session related presence information may indicate whether or not the monitored person is using a speaker phone, handset, or headset, or whether the user terminal 26 engaged in the active communication session is a wireline or wireless telephone. The session related presence information may indicate whether or not the user terminal 26 has a mute function activated as well as identify various participants in an active communication session. Both of these features are particularly useful in conference settings. Further, the presence information may provide various capabilities of the monitored person, the user terminal 26, which is engaged in the active communication session, or associated devices or applications that are available to the monitored person. For example, the session related presence information may alert subscribers engaged in an active communication session with a user that the user has access to certain business applications and alternate communication applications, such as e-mail, instant messaging, or video conferencing applications.

While the session related presence information generally provides information of greater detail or greater relevance for those subscribers engaged in an active communication session with the user, the basic presence information provided to subscribers who are not engaged in an active communication session with the user will generally provide much less detail. For example, the basic presence information may simply indicate whether a user is available for communications and identify the best way to communicate with the user based on the user's location or other state information. Those skilled in the art will recognize various types of information that may be provided in session related presence information and basic presence information. The present invention generates different presence information based on whether or not the subscriber to the presence information is actively engaged in a communication session with the monitored person.

In another embodiment of the present invention, initiation of communication sessions are controlled based on user defined conditions, which are defined by the user who is initiating the communication session. In essence, certain user defined conditions associated with the destination party, terminal, or environment must be met to allow a session to be established in response to a session initiation attempt. For example, if the destination terminal is a wireless device or answered in a speaker phone mode, a session initiation attempt to the destination terminal may be dropped before allowing the session to be established.

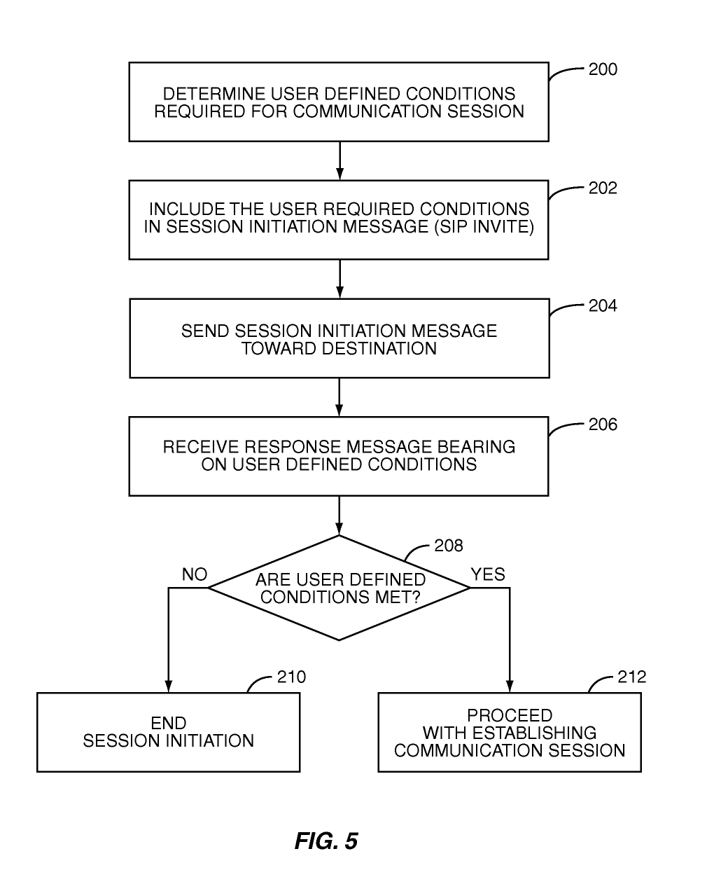

A flow diagram illustrating operation of this embodiment of the present invention is provided in FIG. 5. Initially, the user defined conditions required for establishing a communication session are determined (step 200). Again, these user defined conditions are conditions associated with the destination environment, which is defined to include conditions associated with the destination terminal or devices associated with the destination terminal. The user defined conditions are set by the user who is originating a session toward the destination terminal. For example, the originating user may be user 1, who is associated with user terminal 26, and the destination terminal may be one of the buddy terminals 18(A-D).

Upon receiving instructions from the originating user to initiate a session with a destination terminal, the user required conditions are provided in a session initiation message, such as a Session Initiation Protocol (SIP) invite message (step 202), and the session initiation message is sent toward the destination terminal (step 204). Upon receipt of the session initiation message, the destination terminal or a representative thereof will determine whether or not the user defined conditions are met and will provide a response message indicating whether or not the user defined conditions are met at the destination terminal. Upon receipt of the response message, bearing on the user defined conditions (step 206), a determination is made as to whether the user defined conditions are met (step 208). If the user defined conditions are not met, the session initiation attempt is ended (step 210). If the user defined conditions are met (step 208), session initiation is allowed to proceed to establish the communication session (step 212).

The above functionality may be provided in the user terminal 26 that is initiating the communication session with the destination terminal, in a service node 28, which may be acting as a proxy for the user terminal 26, or a session controller, which facilitates communications between the user terminal 26 and the destination terminal, such as one of the buddy terminals 18(A-D). Those skilled in the art will recognize a number of available user defined conditions that may be required by the originator of a communication session to enable a session initiation to proceed to establishment of a communication session.

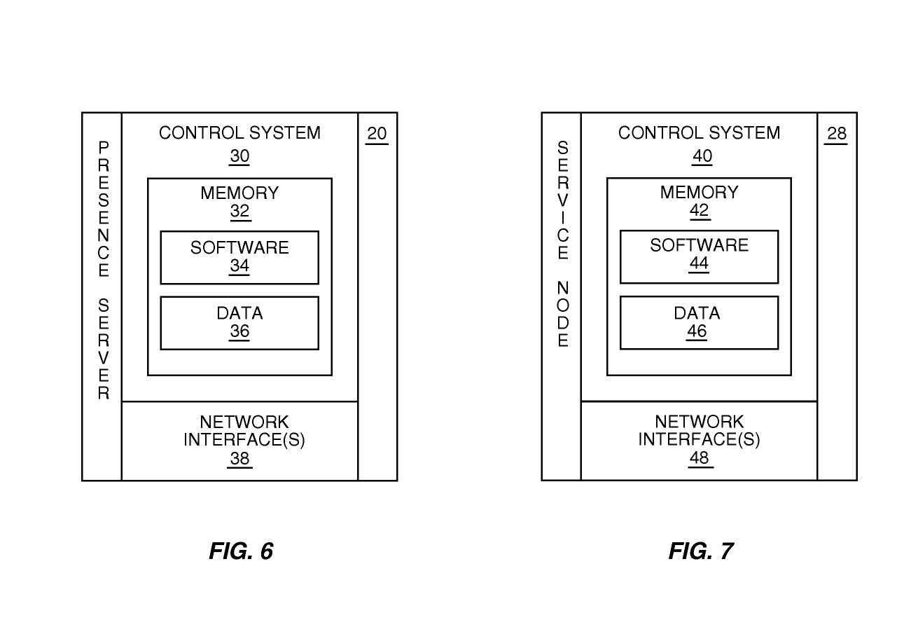

With reference to FIG. 6, a block representation of a presence server 20 is illustrated as having a control system 30 with sufficient memory 32 for the requisite software 34 and data 36 to operate as described above. The presence function 22 may be implemented in the software 34. The control system 30 may also be associated with one or more network interfaces 38 to facilitate communications with the various monitored entities 14 and subscriber entities 18, as well as any other network entity such as the service node 28.

With reference to FIG. 7, a block representation of a service node 28 is illustrated. The service node 28 will include a control system 40 having sufficient memory 42 for the requisite software 44 and data 46 to operate as described above. The control system 40 may also be associated with one or more network interfaces 48 to facilitate communications with various network entities, such as the communication terminals 26 and the presence server 20, if necessary. The service node 28 may take on proxy or session control functions depending on the configuration of the communication environment. Additionally a presence server function could be resident inside a service node 28.

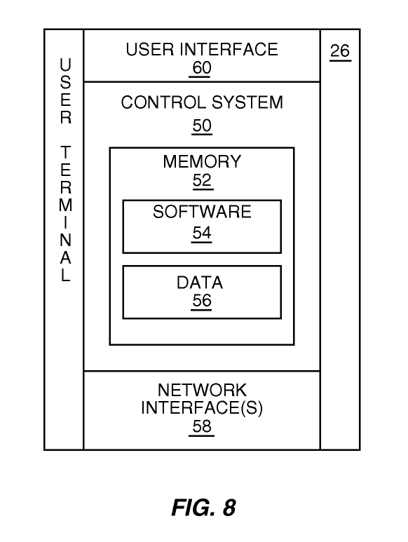

With reference to FIG. 8, a block representation of a user terminal 26 is illustrated. The user terminal 26 will include a control system 50 having sufficient memory 52 for the requisite software 54 and data 56 to operate as described above. In select embodiments, the presence function 22 may be implemented in the software 54. The control system 50 may also be associated with one or more network interfaces 58 to facilitate communications with various network entities, such as the buddy terminals 18(A-D), the presence server 20, and the service node 28. The controls system 50 is also associated with a user interface 60, which may include a microphone, speaker, display, keyboard, and the like to facilitate communication sessions as well as provide information to the user as well as receive information from a user.

Those skilled in the art will recognize improvements and modifications to the preferred embodiments of the present invention. All such improvements and modifications are considered within the scope of the concepts disclosed herein and the claims that follow.

What is claimed is:

1. A method comprising:
determining whether a monitored person is engaged in a communication session with a subscriber who has subscribed to receive presence information associated with the monitored person;
creating the presence information based on whether the monitored person is engaged in the communication session with the subscriber; and
effecting delivery of the presence information to the subscriber.

2. The method of claim 1 wherein when the subscriber is not engaged in the communication session, the presence information delivered to the subscriber is basic presence information, and when the subscriber is engaged in the communication session, the presence information delivered to the subscriber is session related presence information.

3. The method of claim 2 wherein the session related presence information provides greater detail regarding at least one of the monitored person, a communication device associated with the monitored person, and an environment associated with the monitored person than the basic presence information.

4. The method of claim 2 wherein the session related presence information identifies participants in the communication session.

5. The method of claim 1 wherein:
identifying whether the monitored person is engaged in the communication session with the subscriber further comprises:
identifying at least one session subscriber who has subscribed to receive the presence information for the monitored person and is engaged in the communication session, and
identifying at least one non-session subscriber who has subscribed to receive the presence information for the monitored person and is not engaged in the communication session;
creating the presence information comprises creating session related presence information for the at least one session subscriber and creating basic presence information for the at least one non-session subscriber; and
effecting delivery of the presence information comprises effecting delivery of the session related presence information to the at least one session subscriber and effecting delivery of the basic presence information to the at least one non-session subscriber.

6. The method of claim 1 further comprising determining state information associated with the monitored person.

7. The method of claim 6 wherein the presence information is further based on the state information.

8. The method of claim 6 further comprising receiving the state information from at least one of a group consisting of a monitored entity associated with the monitored person and a communication network supporting the monitored entity.

9. The method of claim 1 wherein the presence information bears on a relative availability for communications of the monitored person.

10. A system comprising:
a network interface; and
a control system associated with the network interface and adapted to:
determine whether a monitored person is engaged in a communication session with a subscriber who has subscribed to receive presence information associated with the monitored person;
create the presence information based on whether the monitored person is engaged in the communication session with the subscriber; and
effect delivery of the presence information to the subscriber.

11. The system of claim 10 wherein when the subscriber is not engaged in the communication session, the presence information delivered to the subscriber is basic presence information, and when the subscriber is engaged in the communication session, the presence information delivered to the subscriber is session related presence information.

12. The system of claim 11 wherein the session related presence information provides greater detail regarding at least one of the monitored person, a communication device associated with the monitored person, and an environment associated with the monitored person than the basic presence information.

13. The system of claim 11 wherein the session related presence information identifies participants in the communication session.

14. The system of claim 10 wherein:
to identify whether the monitored person is engaged in the communication session with the subscriber, the control system is further adapted to:
identify at least one session subscriber who has subscribed to receive presence information for the monitored person and is engaged in the communication session; and
identify at least one non-session subscriber who has subscribed to receive presence information for the monitored person and is not engaged in the communication session;
to create the presence information, the control system is further adapted to create session related presence information for the at least one session subscriber and create basic presence information for the at least one non-session subscriber; and
to effect delivery of the presence information, the control system is further adapted to effect delivery of the session related presence information to the at least one session subscriber and effect delivery of the basic presence information to the at least one non-session subscriber.

15. The system of claim 10 wherein the control system is further adapted to determine state information associated with the monitored person.

16. The system of claim 15 wherein the presence information is further based on the state information.

17. The system of claim 15 wherein the control system is further adapted to receive the state information from at least one of a group consisting of a monitored entity associated with the monitored person and a communication network supporting the monitored entity.

18. The system of claim 10 wherein the presence information bears on a relative availability for communications of the monitored person.

19. A method comprising:
creating a session initiation message to establish a communication session between an originating terminal of a first user and a destination terminal, the session initiation message comprising user required conditions, which define conditions provided by the first user and that must be met by at least one of a group consisting of the destination terminal and an environment associated with the destination terminal;
determining whether the user required conditions are met by the at least one of the group consisting of the destination terminal and the environment associated with the destination terminal; and
preventing establishment of the communication session when the user required conditions are not met by the at least one of the group consisting of the destination terminal and the environment associated with the destination terminal.

20. The method of claim 19 further comprising sending the session initiation message toward the destination terminal and receiving a response message comprising information bearing on whether the user required conditions are met, wherein determining whether the user required conditions are met further comprises analyzing the information in the response message to determine whether the user required conditions are met.
